(19) United States
(12) Patent Application Publication
(10) Pub. No.: US 2006/0001729 A1
(43) Pub. Date: Jan. 5, 2006

(54) Paper feeder for roll-shaped recording paper

(75) Inventor: Katsuya Inana, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/170,139

(22) Filed: Jun. 30, 2005

(30) Foreign Application Priority Data
Jul. 2, 2004 (JP) 2004-197190

(51) Int. Cl. B41J 11/00

(52) U.S. Cl. 347/218

(57) ABSTRACT

Roll holders are respectively attached to both ends of a recording paper roll. An edge index is rotatably attached to one of the roll holders. The edge index is provided with an arrow-shaped indicia and a high-reflection member. The edge index is set to a rotational position where the indicia points a paper edge residing at a circumferential surface of the recording-paper roll. Upon setting the recording-paper roll to a printer, the high-reflection member is detected by a photoelectronic sensor disposed in the printer. By detecting the high-reflection member, it is possible to find the rotational position of the paper edge of the recording-paper roll.

### BACKGROUND OF THE INVENTION

1. Field of the Invention

The present invention relates to a paper feeder for a roll-shaped recording paper, which comprises a paper-feed roller and an edge separator.

2. Description of the Related Art

In a conventionally-known paper feeder, a recording-paper roll is rotated in a feeding direction to advance a paper edge to a paper feeding port. This paper feeder is disposed in a magazine to which the recording-paper roll is set. Alternatively, the paper feeder is disposed in a loading chamber to be loaded with the recording-paper roll. After the recording-paper roll has been set, an edge separating claw and a paper-feed roller come into contact with a circumferential surface of the recording-paper roll at positions having an interval in a circumferential direction. The paper-feed roller rotates the recording-paper roll in the feeding direction. The edge separating claw disposed at a downstream side of the paper-feed roller in the feeding direction peels the paper edge from the circumferential surface of the recording-paper roll to conduct the paper edge to the paper feeding port. Therefore, when the recording-paper roll has just been set, it is required to position the paper edge at a rotational position between the edge separating claw and the paper-feed roller.

In consideration of this, the printer described in Japanese Patent Laid-Open Publication No. 2000-169013 comprises an edge detecting mechanism for automatically detecting the edge of the recording-paper roll. This edge detecting mechanism rotates the recording-paper roll in a take-up direction to detect the edge during the rotation thereof. The edge detecting mechanism comprises a base roller for abutting on the circumferential surface of the recording-paper roll, an actuator lever for rotating around the base roller, a driven roller attached to a halfway portion of the actuator lever, a first spring for urging the actuator lever so as to make the driven roller abut on the circumferential surface of the recording-paper roll, and a switch for outputting a detection signal. The switch outputs the detection signal in association with a movement of the actuator lever when the driven roller has passed the edge during a reverse rotation of the recording-paper roll.

As described above, the edge detecting mechanism includes the driven roller for abutting on the circumferential surface of the recording-paper roll. In this mechanism, the movement of the driven roller having passed the edge is detected by a detector. This kind of the mechanism is also employed for a printer described in Japanese Patent Laid-Open Publication No. 2002-179308.

The above edge detecting mechanism rotates the recording-paper roll in the take-up direction to automatically detect the rotational position of the edge in the circumferential direction of the recording-paper roll. Thus, an operation is simple at the time of setting of the recording-paper roll. However, since the edge detecting mechanism needs many parts of the rollers, the detector and so forth besides the paper-feed roller and the edge separating claw, a structure thereof becomes complicated and a lot of trouble is taken in an assembly operation. Moreover, the cost of the entire apparatus increases because of the large number of the parts. Meanwhile, the edge detecting mechanism has a small size for the purpose of detecting the edge of the recording-paper roll. Thus, when setting the recording-paper roll, the edge detecting mechanism is likely to be broken or damaged if the recording-paper roll hits this mechanism due to a setting attitude thereof. Further, the edge detecting mechanism is likely to malfunction due to an effect of paper dust collected during long-term use, and due to deterioration of the spring.

### SUMMARY OF THE INVENTION

In view of the foregoing, it is a primary object of the present invention to provide a low-cost paper feeder in which it is possible to surely detect a rotational position of a paper edge of a recording-paper roll.

In order to achieve the above and other objects, the paper feeder according to the present invention comprises a pair of roll holders, an edge-indexing member, a detector and a controller. The roll holders are respectively attached to both ends of a core of a recording-paper roll so as to catch the recording-paper roll. The roll holders rotate together with the core. The edge-indexing member is rotatably attached to an outer surface of one of the roll holders. An indicia for pointing a position of the paper edge is indicated on the edge-indexing member. After setting the roll holder to the recording-paper roll, the edge-indexing member is attached to the roll holder so as to point the paper edge with the indicia. While the recording-paper roll is rotated in a take-up direction, the detector detects a rotational position of the edge-indexing member to send a detection signal in accordance with the rotational position. On the basis of the detection signal, the controller sets the recording-paper roll to an initial rotational position.

Incidentally, the edge-indexing member may be provided with the indicia and an object to be detected by the detector. The object to be detected is fixed to a position related to the indicia. It is needless to say that the indicia itself may be detected by the detector.

In the paper feeder according to the present invention, the edge-indexing member attached to one of the roll holders is set such that the indicia points the paper edge. The rotational position of the edge-indexing member is detected by the detector. Thus, it is possible to easily find the edge position of the recoding-paper roll. Moreover, it is possible to manufacture the paper feeder at low cost, since a number of parts is reduced in comparison with a conventional paper-edge detecting mechanism. Further, since the detector detects the rotational position of the edge-indexing member from the side of the roll holder, damage and so forth are hardly caused and the detection of the rotational position is surely performed for a longer time in comparison with a conventional mechanism in which a detector is disposed on a circumferential surface of the recording-paper roll.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a perspective view partially showing a printer using a paper feeder according to the present invention;

FIG. 2 is an exploded perspective showing a recording-paper roll unit;

FIG. 3 is a partial perspective view of the printer showing a loading chamber of the printer;

FIG. 4 is an explanatory illustration showing the loading chamber loaded with the recording-paper roll unit;

FIG. 5 is a schematic section view showing a sensor disposed in the loading chamber;

FIG. 6 is an explanatory illustration schematically showing an electrical structure of the printer; and

FIG. 7 is an explanatory illustration showing the loading chamber in which the recording-paper roll is set to an initial rotational position.

### DETAILED DESCRIPTION OF THE PREFERRED EMBODIMENT(S)

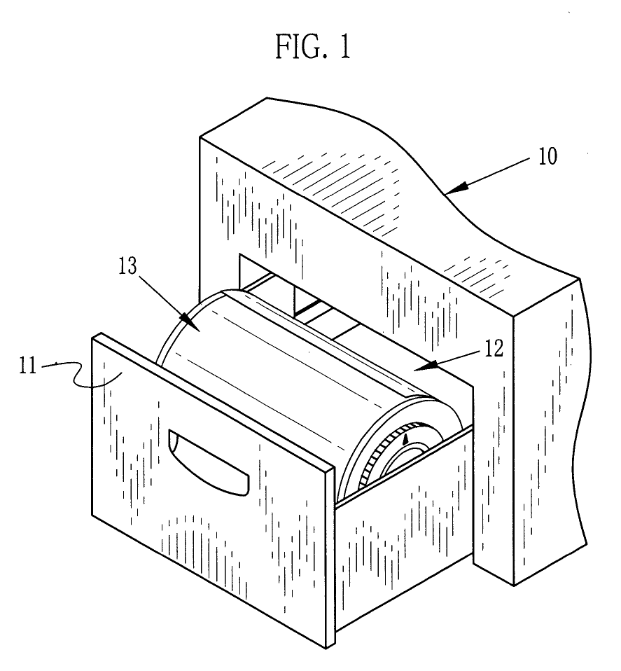

As shown in FIG. 1, a printer 10 using a paper feeder according to the present invention has a loading lid 11 provided at a lateral side thereof. The loading lid 11 is slidable in a drawing direction. When the loading lid 11 is drawn, a loading chamber 12 is exposed from the inside. A recording-paper roll unit 13 is removably loaded in the loading chamber 12.

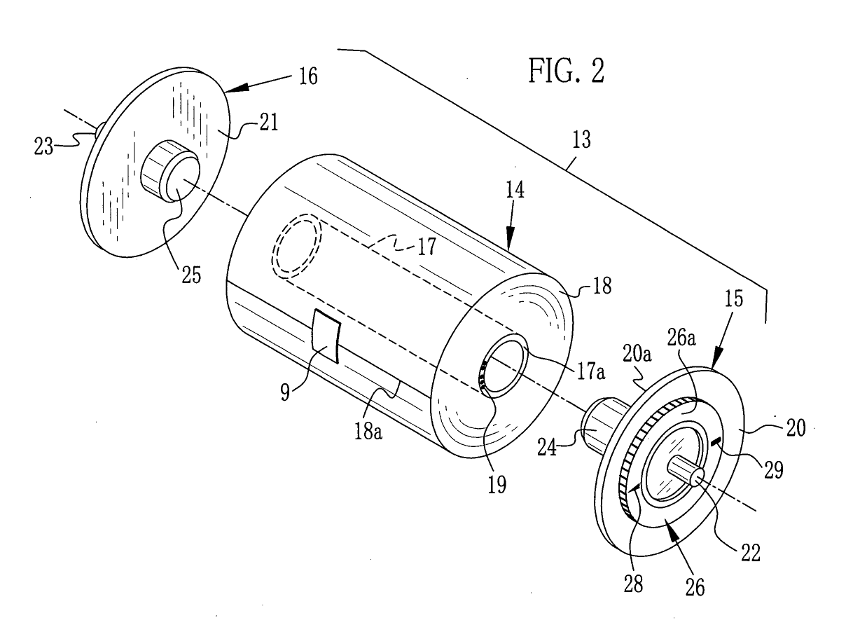

As shown in FIG. 2, the recording-paper roll unit 13 comprises a recording-paper roll 14 and a pair of roll holders 15 and 16. The recording-paper roll 14 is formed such that a strip of a recording paper 18 is wound around a core 17 of a hollow cylindrical shape. Incidentally, an edge 18a of the new recording-paper roll 14 is secured with a tape 9.

A code 19 representing management information of the recording paper 18 is recorded on one end of the core 17. The code 19 represents the information concerning a sort of the recording paper, a manufacturer, manufacture information and an identification number. Further, the code 19 also represents the information concerning thermal sensitivity when the recording paper is a thermosensitive recording paper. For example, the code 19 is formed in a bar-code style wherein a low-reflection region and a high-reflection region are combined. The low-reflection region includes a quiet zone and a black bar. The high-reflection region is a white bar. By the way, the code is not limited to the bar-code style, and may have a circular-shape style. In this case, the code is formed such that the inside of the circular area corresponds to the white bar of the high-reflection region and the outside of the circular area corresponds to the black bar of the low-reflection region.

The roll holders 15 and 16 comprise flanges 20 and 21, shafts 22 and 23, and core shafts 24 and 25. The flanges 20 and 21 catch both ends of the recording-paper roll 14 to position the recording paper 18 in a width direction thereof. The core shafts 24, 25 and the shafts 22, 23 are respectively formed so as to straightly protrude in opposite directions at both sides of the flanges 24 and 25. The core shafts 24 and 25 are fitted into the core 17 of the recording-paper roll 14. The shafts 22 and 23 are rotatably attached to bearings disposed at the loading chamber 12. The core shafts 24 and 25 are inserted into the core 17 to catch both ends of the recording-paper roll 14 with the flanges 20 and 21. Thus, the roll holders 15 and 16 rotate together with recording-paper roll 14.

The roll holder 15 is provided with an edge index 26 for indicating a position of the edge 18a residing at the circumferential surface of the recording-paper roll 14. The edge index 26 is rotatable around the shaft 22 and is attached to the opposite side to the inner side of the flange 20 coming into contact with the end side of the recording-paper roll 18. The edge index 26 has a dial-shaped circumference on which knurls are formed for putting a finger. Further, a front side of the index 26 is provided with an arrow-shaped indicia 28 and a high-reflection member 29. The edge index 26 is set to a rotational position where an arrow direction of the indicia 28 is adjusted to the edge 18a residing at the circumferential surface of the recording-paper roll 14. The high-reflection member 29 is disposed at a position shifted by a predetermined angle, for example by 180 degrees, from the indicia 28 relative to the shaft 22 (rotational center). The high-reflection member 29 is formed from material having higher reflectance in comparison with the other portion (low-reflection portion). This material is a mirror seal, for instance. The high-reflection member 29 is detected by a photoelectronic sensor disposed at the loading chamber 12. Incidentally, it is desirable to provide a ratchet stop and a click mechanism between the edge index 26 and the roll holder 15 so that click feeling is obtained every predetermined angle when the rotational position of the edge index 26 is adjusted. Further, by the ratchet stop and the click mechanism, the set position is prevented from being mistakenly shifted.

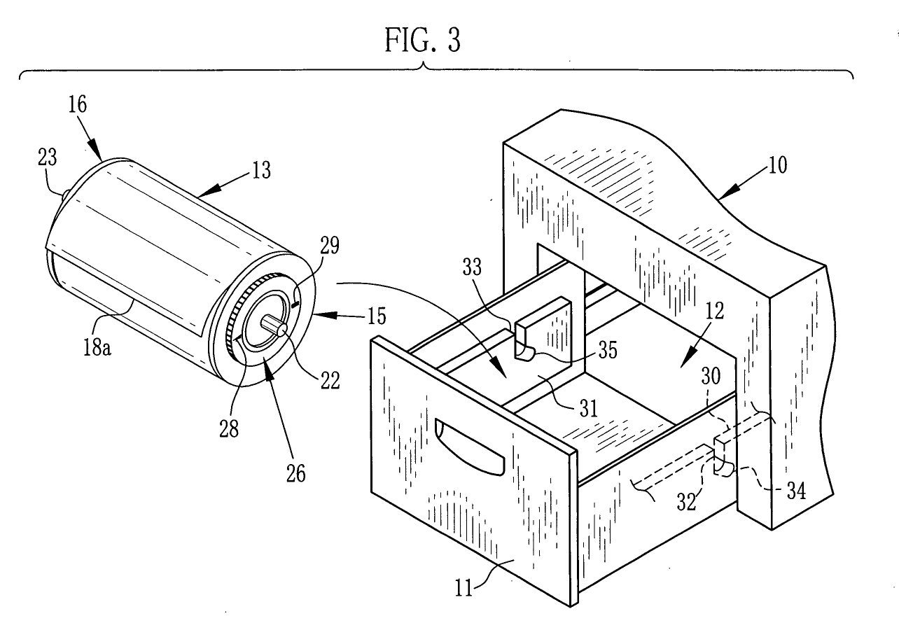

As shown in FIG. 3, a pair of side plates 30 and 31 is disposed in the loading chamber 12 so as to face each other in a direction perpendicular to a drawing direction of the loading lid 11. The side plates 30 and 31 are respectively provided with guide grooves 32 and 33 into which the shafts 22 and 23 of the roll holders 15 and 16 are inserted. Bearings 34 and 35 are formed downstream in a guiding direction of the guide grooves 32 and 33 to guide the shafts 22 and 23. The pair of the bearings 34 and 35 rotatably supports the pair of the shafts 22 and 23 at a constant position.

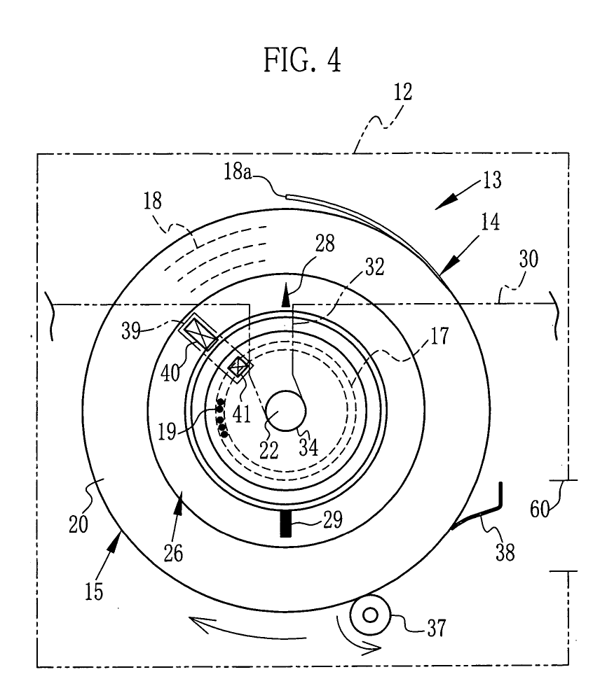

As shown in FIG. 4, the loading chamber 12 is provided with a paper-feed roller 37, an edge separating claw 38 and a sensor unit 39. The paper-feed roller 37 comes into contact with a circumferential surface of the recording-paper roll 14 to rotate this roll 14 in a paper-feed direction and a take-up direction. The edge separating claw 38 is disposed at a downstream side of the paper-feed roller 37 in the paper-feed direction of the recording-paper roll 14 to peel and separate the edge 18a from the recording-paper roll 14 rotating in the paper-feed direction. Drive of the paper-feed roller 37 is inputted from the printer. Incidentally, the paper-feed roller 37 and the edge separating claw 38 are adapted to approach the recording-paper roll 14 in accordance with a change of a winding diameter thereof so as to abut on the circumferential surface of the recording-paper roll 14.

The sensor unit 39 is attached to the side plate 30. The sensor unit 39 is a unit component in which photoelectronic sensors 40 and 41 are unitized. The photoelectronic sensor 40 for detecting the edge 18a senses the high-reflection member 29 and is disposed at an orbit position of the high-reflection member 29 rotating around the shaft 22 set to the bearing 34. The photoelectronic sensor 41 for reading the code 19 is disposed at a rotational orbit position of the end of the core 17 on which the code 19 is recorded. The photoelectronic sensor 40 for detecting the edge 18a is adapted to detect the high-reflection member 29 when the indicia 28 points an area extending between the paper-feed roller 37 and the edge separating claw 38. Incidentally, the couple of the photoelectronic sensors 41 and 40 are arranged along a line passing the center of the shaft 22 set to the bearing 34 for the purpose of unitization.

Each of the photoelectronic sensors 40 and 41 is a reflective sensor having a light emitter and a light receiver. The photoelectronic sensor 41 reads the code 19 while the recording-paper roll 14 is rotated in the take-up direction. The photoelectronic sensor 40 detects the high-reflection member 29 while the recording-paper roll 14 is rotated in the take-up direction.

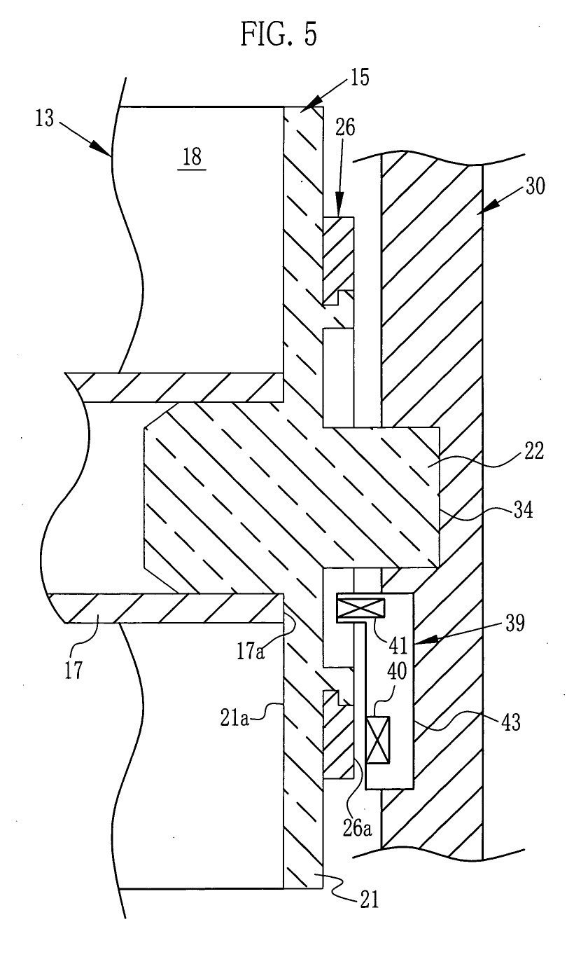

As shown in FIG. 5, the couple of the photoelectronic sensors 40 and 41 are fixed to a block 43, which is attached to the side plate 30. The photoelectronic sensor 40 for detecting the edge 18a is disposed so as to confront a surface 26a having the high-reflection member 29. Meanwhile, the photoelectronic sensor 41 is disposed so as to confront the end 17a of the core 17 on which the code 19 is recorded. Between the photoelectronic sensor 41 and the end 17a, the roll holder 15 is located. In this embodiment, the roll holder 15 is made of transparent material so that the code 19 is read out through the roll holder 15. If only the roll holder 15 to which the edge index 26 is fixed is made of the transparent material, it is possible to prevent the roll holders 15 and 16 from being mistakenly attached to both ends of the recording-paper roll 14. However, both of the roll holders 15 and 16 may be made of the transparent material. By the way, the edge index 26 has a doughnut shape so as not to disturb the detection of the photoelectronic sensor 41 by its opening. Thus, it is unnecessary to form the edge index 26 from the transparent material.

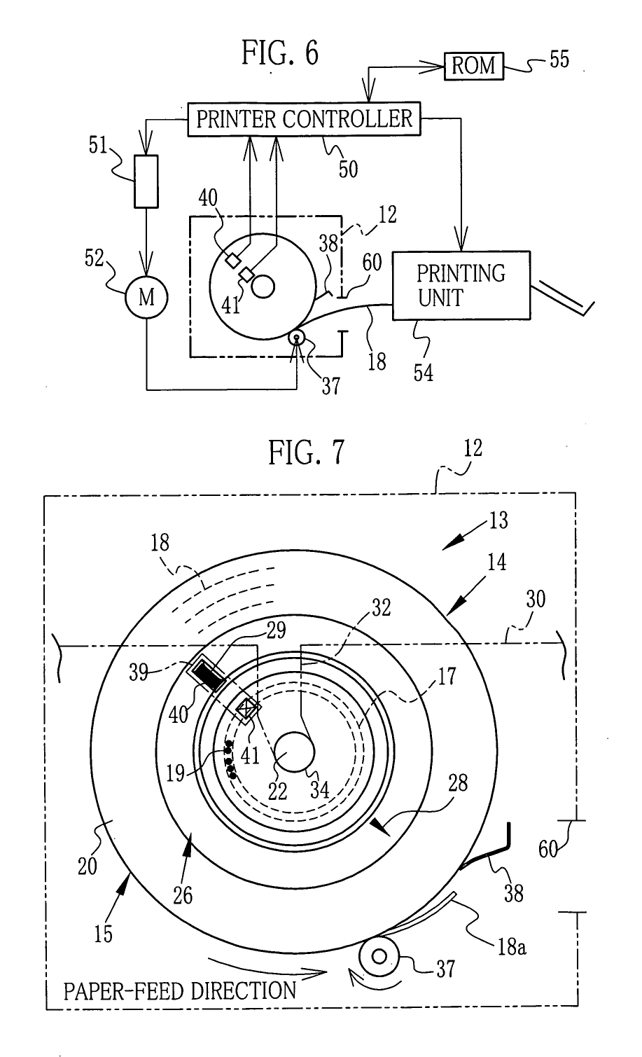

As shown in FIG. 6, a signal obtained from each of the photoelectronic sensors 40 and 41 is sent to a printer controller 50, which controls a paper-feed motor 52 via a driver 51. Drive of the paper-feed motor 52 is transmitted to the paper-feed roller 37 disposed in the loading chamber 12. Further, the printer controller 50 controls a printing unit 54 on the basis of the read code 19 to record an optimum image. Incidentally, the printer controller 50 integrally controls the respective sections along a program read from a ROM 55.

Next, an operation of the above structure is described below. When assembling the recording-paper roll unit 13, the core shafts 24 and 25 of the roll holders 15 and 16 are respectively inserted into openings of both ends of the core 17. After insertion, the edge index 26 attached to the roll holder 15 is set to the rotational position where the indicia 28 points the edge 18a of the recoding-paper roll 14. And then, the tape 9 securing the edge 18a of the recording-paper roll 14 is peeled. Upon this, the recording-paper roll unit 13 becomes available.

Successively, the loading lid 11 of the printer 10 is drawn to expose the loading chamber 12. The recording-paper roll unit 13 is set, bringing the flanges 20 and 21 to the exposed loading chamber 12. At this time, the shaft 22 of the roll holder 15 having the edge index 26 is set to the bearing 34 of the pair of the bearings 34 and 35 residing in the loading chamber 12. By doing so, the recording-paper roll unit 13 is set in a state that the edge 18a is fed by rotating the paper-feed roller 37 in the paper-feed direction.

Upon closing the loading lid 11, the paper-feed roller 37 and the edge separating claw 38 come into contact with the circumferential surface of the recording-paper roll 14. After that, it is detected whether there is or not the recording-paper roll unit 13. When there is the roll unit 13, the printer controller 50 performs a print preparing operation in which the operation for reading the code 19 is performed first, and then, the operation for detecting the rotational position of the edge index 26 is performed. After performing these operations, the printer 10 is kept in a readiness state.

In the operation for reading the code 19, the paper-feed motor 52 is driven to rotate the paper-feed roller 37 in the take-up direction. At this time, the recording-paper roll 14 makes at least one rotation. During this rotation, the photoelectronic sensor 41 is monitored to read the code 19 on the basis of a high-level signal and a low-level signal obtained from the photoelectronic sensor 41.

After reading the code 19, the printer controller 50 continues rotating the paper-feed roller 37 in the take-up direction to monitor the edge-detecting photoelectronic sensor 40 during this time. The photoelectronic sensor 40 detects the high-reflection member 29. The printer processor 50 halts the drive of the paper-feed motor 52 upon reception of a leading-edge signal, which is obtained when the signal from the photoelectronic sensor 40 rises from the low level to the high level. Alternatively, the printer controller 50 halts the drive of the paper-feed motor 52 after a predetermined period has passed from the reception of the leading-edge signal. In virtue of this, as shown in FIG. 7, the rotation of the recording-paper roll 14 is stopped at a position where the high-reflection member 29 substantially overlaps with the photoelectronic sensor 40 in a side viewing direction. At this time, the edge 18a residing on the circumferential surface of the recording-paper roll 14 is kept in an initial rotational position located between the paper-feed roller 37 and the edge separating claw 38. Hereby, the printer 10 is set in a print readiness state. In this way, reading the code 19 and detecting the rotational position of the edge index 26 are successively performed while the paper-feed roller 37 is rotated in the take-up direction. Thus, the print preparing operation is speedily performed.

The recording paper 18 of this embodiment is a well-known color thermosensitive recoding paper in which cyan, magenta and yellow thermosensitive coloring layers are formed on a support in order.

The printing unit 54 includes a carrying roller pair, a thermal head and an optical fixing unit and so forth. The carrying roller pair nips the edge 18a of the recording paper 18 and carries it in the printing unit 54. The thermal head performs thermal recording for the respective thermosensitive coloring layers of the recording paper 18. The optical fixing unit optically fixes the respective thermosensitive coloring layers, for which thermal recording has been performed, by applying ultraviolet rays.

Upon a print instruction, the printer controller 50 drives the paper-feed motor 52 and reverses the paper-feed roller 37 to rotate the recording-paper roll 14 in the paper-feed direction. Hereby, the edge 18a is separated from the roll 14 by means of the edge separating claw 38, and the edge 18a is carried toward a paper slot 60. Then, the recording paper 18 is fed to the printing unit 54. The fed recording paper 18 is carried by the carrying roller pair in the printing unit 54 to pass the thermal head and the optical fixing unit in order. During this time, print processing is performed in a three-color frame sequential manner to record a full-color image. The processed recording paper 18, for which the print processing has been performed, is cut by a cutter into a predetermined size. The cut recording paper 18 is discharged to the outside of the printer 10. Meanwhile, the recording paper 18 from which the image-recoded paper is separated is rewound into the loading chamber 12 by reversing the paper-feed roller 37.

The printing unit 54 is provided with an edge detecting sensor for detecting the edge 18a of the recording paper 18. At the time of rewind of the recording paper 18, control is performed such that the paper-feed motor 52 is driven for a predetermined period after detecting the edge 18a with the edge detecting sensor. If the paper-feed motor 52 is a pulse motor, control is performed such that the paper-feed motor 52 is driven by a number of predetermined pulses after detecting the edge 18a. In virtue of this control, the recording-paper roll 14 is set again to the initial rotational position where the edge 18a is located between the paper-feed roller 37 and the edge separating claw 38.

In the printer 10, it is possible to designate a print number at the time of print instruction. When the designated print number is two or more, print processing is successively performed by times of the designated number. After completing the successive processing, the recording paper 18 is rewound.

With respect to the recording paper 18, there are some kinds having different widths. When the recording paper 18 is exchanged to another one having a different width, the loading lid 12 is drawn to remove the recording-paper roll unit 13. Further, the couple of the roll holders 15 and 16 are detached from the recording-paper roll unit 13. And then, the detached roll holders 15 and 16 are attached to the new recoding-paper roll 14, and the rotational position of the edge index 26 is set. In this way, the rotational position of the edge index 26 is set whenever the recording-paper roll unit 13 is placed. Owing to this, it is possible to surely and easily detect the edge 18a of the recording paper roll 14.

In the above embodiment, the recording-paper roll 14 having the paper information is used. The present information, however, is not limited to this. It is possible to use the recording-paper roll having no paper information. In this case, the photoelectronic sensor 41 may be omitted. Moreover, in this case, it is unnecessary to form the roll holder 15 from the transparent material.

In the above embodiment, the edge index 26 is provided with the indicia 28 and the high-reflection member 29. The present invention, however, is not limited to this. The indicia 28 may be detected as the high-reflection member by the photoelectronic sensor 40. Moreover, the high-reflection member 29 disposed on the surface 26a of the edge index 26 is detected by the photoelectronic sensor 40 of which the light emitter faces the surface 26a. However, the high-reflection member may be disposed on a circumferential surface of the edge index 26, and the light emitter of the photoelectronic sensor may point in a diameter direction to detect the high-reflection member. Further, the photoelectronic sensor is not exclusive as the detecting member. A proximity switch may be used. In this case, a metal member is disposed on the edge index 26 instead of the high-reflection member. In the above embodiments, detection is performed in the non-contact manner. However, contact-type detecting members comprising a projection and a microswitch may be used.

The above embodiment relates to the stationary type in which a rotational axis of the recording-paper roll 14 is rotatably kept in the constant position. However, this is not exclusive. It is possible to adopt a moving type in which the shafts 22 and 23 of the recording-paper roll unit 13 move toward the paper-feed roller 37 in accordance with the change of the winding diameter of the recoding-paper roll 14. In this case, the photoelectronic sensors 40 and 41 are moved in association with the movement of the shafts 22 and 23 of the recording-paper roll unit 13 in the same direction and at the same speed.

In the above embodiment, the recording-paper roll 14 is rotated in the paper-feed direction and the take-up direction by rotating the paper-feed roller 37 forward and backward. However, only when the recording paper is taken up, drive may be inputted into the roll holder from the printer to rotate the recording-paper roll 14 in the take-up direction.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A paper feeder for a recording-paper roll in which a strip of a recording paper is wound around a core in a roll form, said paper feeder rotating said recording-paper roll in a feeding direction to feed the recording paper, said paper feeder comprising:
a paper-feed roller coming into contact with a circumferential surface of said recording-paper roll to rotate said recording-paper roll;
an edge-separating member disposed at a downstream side of said paper-feed roller in the feeding direction of said recording-paper roll, said edge-separating member peeling and separating an edge of said recording paper, which resides at said circumferential surface of said recording-paper roll, from said recording-paper roll when said recording-paper roll is rotated in the feeding direction;
a pair of roll holders respectively attached to both ends of said core so as to catch both sides of said recording-paper roll, said roll holders rotating together with said core;
an edge-indexing member rotatably attached to an outer surface of one of said roll holders, an index for pointing a position of said edge being indicated on an outer surface of said edge-indexing member, which is set such that said index points said edge after setting said roll holder to said recording-paper roll;
a detector for detecting a rotational position of said edge-indexing member while said recording-paper roll is rotated in a take-up direction opposite to the feeding direction, said detector outputting a detection signal in accordance with said rotational position; and
a controller for setting said edge of said recording paper to an initial rotational position, which is located between said paper-feed roller and said edge-separating member, on the basis of said detection signal.

2. A paper feeder according to claim 1, wherein said edge-indexing member is provided with an indicia being as said index, and an object to be detected by said detector, said object to be detected being fixed to a position related to said indicia.

3. A paper feeder according to claim 2, wherein said indicia has an arrow shape whose direction points said edge of said recording paper.

4. A paper feeder according to claim 2, wherein said object to be detected is fixed to the position shifted by 180 degrees from said indicia relative to the center of said edge-indexing member.

5. A paper feeder according to claim 4, wherein said object to be detected is a high-reflection member having higher reflectance in comparison with other portions of said edge-indexing member.

6. A paper feeder according to claim 5, wherein said detector for detecting said object is a photoelectronic sensor.

7. A paper feeder according to claim 6, wherein said edge-indexing member has a doughnut shape.

8. A paper feeder according to claim 1, further comprising:
a pair of plates for rotatably supporting the pair of said roll holders.

9. A paper feeder according to claim 8, wherein said detector is fixed to said plate rotatably supporting said roll holder to which said edge-indexing member is attached.
